(19) United States
(12) Patent Application Publication
(10) Pub. No.: US 2024/0411493 A1
(43) Pub. Date: Dec. 12, 2024

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventors: SHINTARO TAKEI, TOKYO (JP); YU NAKADA, TOKYO (JP); HIROKI GOHARA, TOKYO (JP); HAJIME WAKABAYASHI, TOKYO (JP); TAKUMI NAKAMURA, TOKYO (JP)

(21) Appl. No.: 18/704,526

(22) PCT Filed: Sep. 21, 2022
(86) PCT No.: PCT/JP2022/035059

§ 371 Date: Apr. 25, 2024

(30) Foreign Application Priority Data
Nov. 4, 2021 (JP) 2021-180566

(51) Int. Cl. G06F 3/14

(52) U.S. Cl. CPC G06F 3/14

(57) ABSTRACT

To realize that a user experiences an application accompanied by image display with high quality while reducing power consumption. An information processing device according to an embodiment of the present disclosure is an information processing device that performs processing based on a first image captured by a camera, the information processing device including a control unit that controls, in a case where state information indicating a state of the information processing device indicates a first state, a display image to be displayed in a display region on the basis of the first image, and that controls, in a case where the state information indicates a second state, a first partial display image to be displayed in a first partial region of the display region on the basis of the first image, and controls a second partial display image to be displayed in a second partial region of the display region on the basis of a second image different from the first image.

### TECHNICAL FIELD

The present disclosure relates to an information processing device, an information processing method, and a recording medium.

### BACKGROUND ART

There is a game (AR game) performed by a plurality of users wearing a video see-through type head mounted display (HMD) using augmented reality by sharing the same space. In a case where a remaining battery level differs depending on the HMD, the timing at which the battery runs out differs between users, and a difference occurs in an experience time of enjoying the AR game. Furthermore, even in a case where a processing amount of data and processing performance are different for each HMD, the remaining battery level is affected, and thus a similar problem occurs.

On the other hand, in the HMD, power consumption increases with an increase in resolution and with an increase in processing amount, and reduction in battery consumption is a major problem.

### CITATION LIST

### Patent Document

Patent Document 1: Japanese Patent Application Laid-Open No. 2020-98638

Patent Document 2: Japanese Patent Application Laid-Open No. 2020-86721

### SUMMARY OF THE INVENTION

### Problems to be Solved by the Invention

The present disclosure has been made in view of the above-described problems, and an object thereof is to realize that a user experiences an application accompanied by image display with high quality while reducing power consumption.

### Solutions to Problems

An information processing device according to an embodiment of the present disclosure is an information processing device that performs processing based on a first image captured by a camera, the information processing device including a control unit that controls, in a case where state information indicating a state of the information processing device indicates a first state, a display image to be displayed in a display region on the basis of the first image, and that controls, in a case where the state information indicates a second state, a first partial display image to be displayed in a first partial region of the display region on the basis of the first image, and controls a second partial display image to be displayed in a second partial region of the display region on the basis of a second image different from the first image.

### BRIEF DESCRIPTION OF DRAWINGS

FIG. 1 is a block diagram of a head mounted display (HMD) as an information processing device according to an embodiment of the present disclosure.

FIG. 2 is a diagram illustrating a plurality of HMDs existing in the same space and a server over a network.

FIG. 3 is a diagram schematically illustrating an example in which a server acquires a distant view image and the like and manages the distant view image and the like in an internal database.

FIG. 4 is a diagram illustrating an example of a display image displayed on a display unit of the HMD.

FIG. 5 is a flowchart illustrating an example of processing of the HMD according to the embodiment of the present disclosure.

FIG. 6 is a flowchart following FIG. 5.

FIG. 7 is a flowchart following FIG. 6.

FIG. 8 is a flowchart following FIG. 7.

### MODE FOR CARRYING OUT THE INVENTION

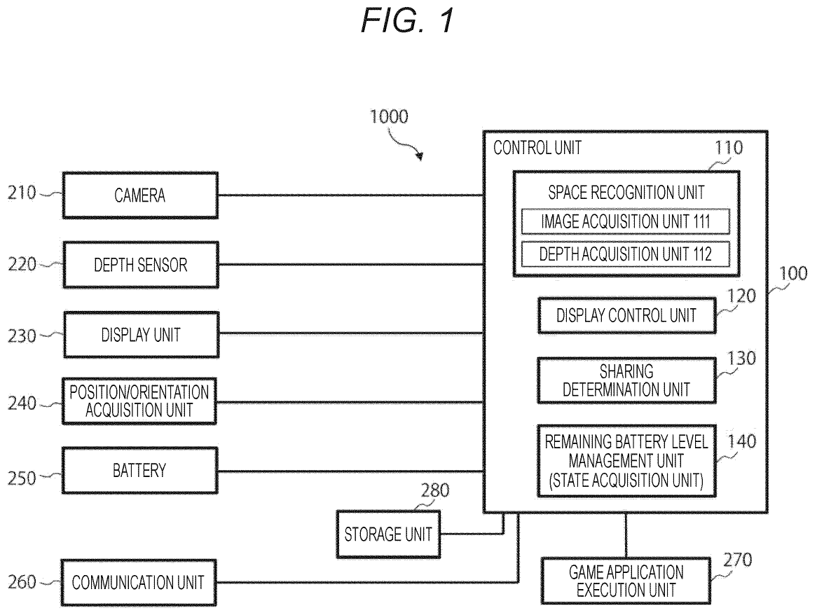

FIG. 1 is a block diagram of a head mounted display (HMD) 1000 as an information processing device according to an embodiment of the present disclosure. The HMD 1000 includes a control unit 100, a camera 210, a depth sensor 220, a display unit 230, a position/orientation acquisition unit 240, a battery 250, a communication unit 260, a game application execution unit 270, and a storage unit 280. The control unit 100 includes a space recognition unit 110, a display control unit 120, a sharing determination unit 130, and a remaining battery level management unit 140 (state acquisition unit). In the present embodiment, an example in which the information processing device is mounted on the HMD will be described, but the information processing device may be mounted on an XR device such as AR glasses, VR glasses, or MR glasses, or information terminal equipment such as a smartphone or a tablet. The information processing device according to the present embodiment includes at least the control unit 100 in FIG. 1, and can additionally include other elements.

The camera 210 is a sensor that captures an image of the surrounding environment and acquires an image of the surrounding environment. The image captured by the camera 210 may be a still image or a video. As the surrounding environment, for example, there is a landscape. Hereinafter, a case where the camera 210 captures a landscape and acquires a landscape image is assumed, but the present disclosure is not limited to this example. The camera 210 is, for example, a luminance camera such as an RGB camera and a monochrome camera. The image acquired by the camera 210 includes a luminance value for each pixel.

The depth sensor 220 is a sensor that acquires depth information indicating a depth (distance) with respect to the surrounding environment by sensing. The depth information is acquired as a depth image including a depth value (distance value) for each pixel. The depth sensor 220 includes, for example, a stereo camera, a time-of-flight (ToF) camera, or a light detection and ranging (LiDAR) camera.

The camera 210 and the depth sensor 220 operate in synchronization with each other. For example, the camera 210 and the depth sensor 220 simultaneously perform sensing. The camera 210 and the depth sensor 220 may perform sensing at regular time intervals. In the example of FIG. 1, the camera 210 and the depth sensor 220 are separate sensors, but may be integrated sensors. In a case where the depth information can be acquired from the captured image of the camera 210 by the monocular ranging technology, a configuration in which the depth sensor 220 is omitted may be adopted.

An imaging range (sensing range) of the camera 210 and an imaging range (sensing range) of the depth sensor 220 are the same. That is, an angle of view of the camera 210 and an angle of view of the depth sensor 220 of the same HMD 1000 are the same. However, the angle of view of the camera 210 and the angle of view of the depth sensor 220 of the HMD 1000 are not necessarily the same. For example, the angle of view of the depth sensor 220 may be wider than the angle of view of the camera 210. By associating the captured image of the camera 210 with the depth image (depth information) of the depth sensor 220, the depth value of each pixel of the image captured by the camera 210, that is, the depth value of a part (environment part) corresponding to each pixel in the surrounding environment can be acquired. The captured image of the camera 210 can be divided into a plurality of objects by semantic segmentation and the like, and the depth value of each object can be calculated on the basis of the depth information. For example, the average of the depth values of the pixels included in the object is set as the depth value of the object. Furthermore, by using the depth information, the captured image of the camera 210 can be classified into a plurality of parts according to the distance. For example, the captured image can be classified into a distant view image and a near view image. As an example, in the captured images of the camera 210, an image having a depth value less than a threshold can be classified as a near view image (first partial image), and an image part having a depth value equal to or greater than the threshold (second partial image) can be classified as a distant view image.

The storage unit 280 stores data or information necessary for the operation of the HMD 1000. The storage unit 280 stores an image (fixed image) having predetermined contents. The fixed image may be an image having any content, for example, an image of a specific pattern such as a checkered pattern, an image of a specific color, or an image including a specific landscape. The landscape image acquired by the camera 210 and the depth information acquired by the depth sensor 220 may be stored in the storage unit 280. The storage unit 280 may store a database (described later) used in a case where the HMD 1000 functions as a server. In a case where the control unit 100 is executed by a processor such as a central processing unit (CPU), a computer program to be executed by the processor may be stored in the storage unit 280. The storage unit 280 may store an application such as a game application. The storage unit 280 includes, for example, a recording medium such as a memory, a hard disk, or an optical disk. The memory may be a volatile memory or a nonvolatile memory.

The position/orientation acquisition unit 240 acquires position information indicating the current position of the HMD 1000 and orientation information indicating the orientation in which the HMD 1000 faces. The position/orientation acquisition unit 240 acquires the position information and the orientation information at regular time intervals, for example. The position/orientation acquisition unit 240 acquires the position information using, for example, a global positioning system (GPS). The position/orientation acquisition unit 240 acquires the orientation information of the HMD 1000 on the basis of, for example, a gyro or an electronic compass. The position/orientation acquisition unit 240 may acquire the position information or the orientation information by performing position estimation or orientation estimation from a wireless signal received from an external wireless station and the like via the communication unit 260. The position/orientation acquisition unit 240 may compare at least one of the captured image (landscape image) and the depth information with map data (for example, three-dimensional spatial map data), and acquire at least one of the position information and the orientation information on the basis of coincidence between the map data and the at least one of the captured image and the depth information. The map data may be stored in the storage unit 280, or the map data may be acquired from a server on a network (the Internet and the like) to which the HMD 1000 can be connected. Alternatively, in a case where other HMDs store map data, the HMD 1000 may acquire the map data from other HMDs.

The battery 250 supplies power necessary for the operation of the HMD 1000. The battery 250 is, for example, a chargeable/dischargeable battery (storage battery or secondary battery). As the battery 250, a non-chargeable primary battery such as a dry battery may be used. The remaining level of the battery 250 is managed by the remaining battery level management unit 140.

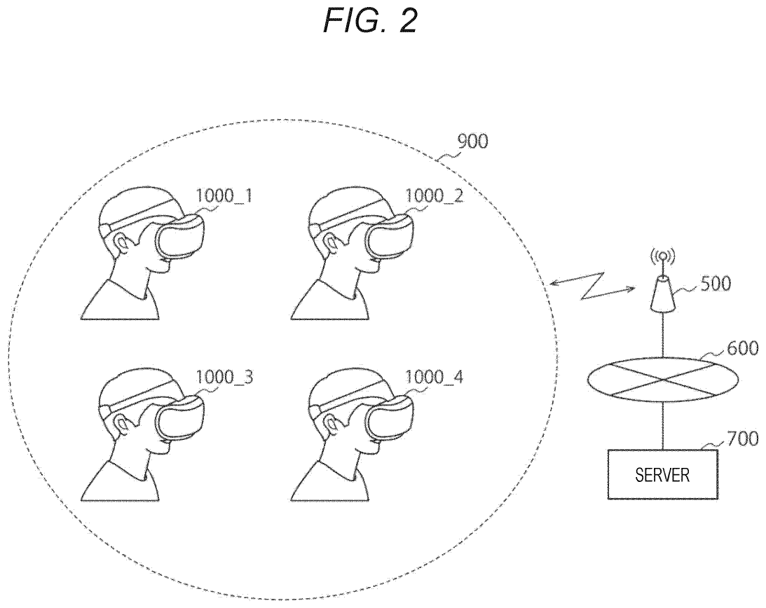

The communication unit 260 communicates with other HMDs and an external server (refer to a server 700 in FIG. 2) in a wired or wireless manner. The communication unit 260 can also communicate with other HMDs and an external server via a relay device.

The space recognition unit 110 of the control unit 100 acquires the captured image (landscape image) of the camera 210 and the depth information of the depth sensor 220. The space recognition unit 110 generates spatial data (image data with depth information) by associating the captured image with the depth image. For example, data in which a depth value is associated with each pixel of the landscape image is set as the spatial data. The spatial data may further include the position information and the orientation information acquired by the position/orientation acquisition unit 240. The space recognition unit 110 includes an image acquisition unit 111 that acquires the captured image of the camera 210, and a depth acquisition unit (distance acquisition unit) 112 that acquires the depth information (distance information) from the depth sensor 220.

The space recognition unit 110 may identify each object included in the captured image by performing semantic segmentation, clustering, or the like on the captured image, and associate a depth value with each object. The space recognition unit 110 classifies, among the captured images included in the spatial data, an image having a depth value less than the threshold as a near view image, and classifies an image having a depth value equal to or greater than the threshold as a distant view image. The classification may be performed on a pixel basis. Alternatively, the classification may be performed in units of objects. The data in which the depth information corresponding to the distant view image is associated with the distant view image is referred to as distant view spatial data (distant view image data with depth information). The distant view spatial data may include at least one of the position information and the orientation information acquired by the position/orientation acquisition unit 240. As described later, in the present embodiment, a mechanism for sharing the distant view spatial data between the HMDs is introduced.

The game application execution unit 270 is an application execution unit that executes an application such as an AR game application (hereinafter, game application). The game application execution unit 270 may be configured by the same hardware as the control unit 100, or may be configured by hardware different from the control unit 100. The game application is a game performed by a plurality of users each wearing the HMD while sharing the same place or space. Therefore, some or all of the images captured by the HMDs of a plurality of users often target the same landscape (environment or a part of environment). In the present embodiment, a case where a game application using AR is executed will be described, but the application may not be a game application as long as the application is performed by sharing the same place or space with other HMDs 1000.

The game application creates an object (image) to be superimposed on the landscape image captured by the camera 210. The object to be created may depend on at least one of the position and orientation of the HMD 1000, or may depend on the surrounding environment (a building and the like existing in the surroundings). The surrounding environment may be specified on the basis of the map data. The control unit 100 may specify the surrounding environment.

The object created by the game application can be superimposed on the landscape image in the display control unit 120. The game application may designate a condition (depth condition) of an image on which an object is to be superimposed. In the present embodiment, a case is assumed in which the game application specifies a near view image (an image having a depth value less than a reference value) as an image on which an object is to be superimposed. The superimposition here may mean that an object is brought into contact with the near view image having the same depth value.

The content of the object created by the game application is not limited to a specific content. For example, the object may be an avatar of the user of the HMD 1000, a character such as an enemy avatar, or an object such as a building, a tree, a vending machine, a vehicle, or a flying object.

The game application execution unit 270 may perform control to synchronize game applications of HMDs of a plurality of users. For example, the game application execution unit 270 acquires an object (for example, information on an avatar representing another user) generated by a game application of another HMD. The acquired object is superimposed and displayed on the landscape image together with the object generated by the game application execution unit 270. Therefore, it is possible to display an object that is being displayed on the HMD of another user, on the HMD 1000 and enjoy an experience of performing the same game (the same application) in cooperation among a plurality of users in a virtual space.

The sharing determination unit 130 of the control unit 100 detects other surrounding HMDs that can execute a game while sharing the same place or space. For example, the sharing determination unit 130 acquires the position information of other HMDs via a management server of the game. The sharing determination unit 130 specifies an HMD existing in the same place or space among other surrounding HMDs on the basis of the position information of the other HMDs and the position information of the HMD 1000. Therefore, the sharing determination unit 130 detects other HMDs that can execute the game application while sharing the same place with the HMD 1000. Alternatively, the sharing determination unit 130 may acquire a list of other HMDs (users) existing in the same place from the management server of the game, and select an HMD (user) to play the game together from the list. Alternatively, the HMD 1000 may detect other HMDs by broadcasting an equipment detection signal including the current position of the HMD 1000 and receiving a response signal from other HMDs existing in the same place. An HMD (user) who plays a game together by a method other than the method described in this paragraph may be selected or detected.

The place or space where the game is played may be, for example, any place such as a park, a town, or a facility. The place where the game is played may be selected from among a plurality of candidates determined in advance in the game, or may be any place where the users gather. In this case, a certain range including the gathered users (HMDs) may be treated as the same place. It may be determined that a plurality of HMDs having a distance equal to or less than a certain value exists in the same place, and a certain range including the plurality of HMDs may be set as the same place. The size and range of the place may be set according to the number of people who play the game and the content of the game. The game application execution unit 270 starts game processing with the game application execution unit 270 of other HMDs that are detected.

FIG. 2 illustrates an example of HMDs 1000_1, 1000_2, 1000_3, 1000_4 existing in the same place or space 900. The HMDs 1000_1 to 1000_4 mutually detect the HMDs on the basis of the position information, assuming that the game application can be executed by sharing the same place. The detected HMDs are connected by the game application, and the users can execute the game by sharing the same place. Note that, although each HMD is oriented in the same direction in the figure, in practice, each HMD can be oriented in an arbitrary direction in the space 900. The HMDs can communicate with each other directly or via a base station 500 (relay device). Furthermore, each HMD can communicate with the server 700 on a network 600 via the base station 500. Any one of the HMDs 1000_1 to 1000_4 can be selected as a server and function as a selection server. In this case, the server 700 may be unnecessary, or the selection server and the server 700 may share roles. Details of the functions performed by the server 700 or the selection server will be described later.

The remaining battery level management unit 140 manages the remaining level of the battery 250. The remaining battery level management unit 140 may calculate a remaining operable time of the HMD 1000, for example, a remaining time during which the game application can be executed, on the basis of the remaining battery level. The remaining operable time may be calculated using specification information of the HMD 1000 (for example, power consumption and the like of the HMD 1000). The remaining battery level management unit 140 may calculate the remaining operable time, for example, at regular time intervals. The remaining battery level management unit 140 acquires battery information indicating the remaining battery level or the remaining operable time at regular time intervals. The battery information is information based on a remaining level of the battery. The battery information may be stored in the storage unit 280. The battery 250 is mounted on the HMD 1000, but may be connected to the HMD 1000 in a wired manner as an external energy storage. Furthermore, the game application may be executed while the battery 250 is charged in a wired or wireless manner.

The remaining battery level or the remaining operable time is an example indicating a state of the HMD 1000. The remaining battery level management unit 140 is an example of a state acquisition unit that acquires state information indicating the state of the HMD 1000. The state of the HMD 1000 acquired by the state acquisition unit is not limited to the remaining battery level and the remaining operable time. For example, the state of the HMD 1000 may be an operation mode (for example, a low power consumption mode or a normal operation mode) of the HMD 1000. Furthermore, the state of the HMD 1000 may be the performance of the HMD 1000, such as the clock frequency of the CPU of the HMD 1000.

The control unit 100 may upload the battery information by transmitting the battery information to the server 700 on the network or the selection server described above via the communication unit 260. The battery information includes the remaining battery level or the remaining operable time. Furthermore, the control unit 100 may download the battery information by receiving the battery information of other HMDs or the battery information of the own HMD 1000 from the server 700 or the selection server via the communication unit 260.

Furthermore, the control unit 100 may provide (upload) the distant view image and the like to the server by transmitting an upload request of the distant view spatial data (for example, the distant view image with depth information, the position information, the orientation information, and the like) to the server (the server 700 or the selection server) via the communication unit 260. The control unit 100 may acquire (download) the distant view image, the depth information thereof, and the like from the server by transmitting an acquisition request of the distant view image and the like according to the position information and the orientation information of the HMD 1000 to the server via the communication unit 260. The data targeted for the upload request and the download request includes at least a distant view image, and further includes at least one of depth information, position information, and orientation information. Details of processing of uploading and downloading the distant view image and the like will be described later.

The display unit 230 is a display panel that displays an image on the basis of the image data received from the display control unit 120. Examples of the display panel include a liquid crystal display panel or an organic electro-luminescence (EL) display panel.

The display control unit 120 controls a display image to be displayed in a display region of the display unit 230. In order to control the display image, for example, spatial data generated by the space recognition unit 110, a fixed image stored in the storage unit 280 or a distant view image and the like acquired from the server (the server 700 or the selection server), and information on the object generated by the game application execution unit 270 are used. The information on the object includes an image, a position, and the like of the object. The display control unit 120 creates image data to be displayed on the display unit 230 and outputs the image data to the display unit 230. The display unit 230 displays an image on the basis of the image data. The display control unit 120 may update the image to be displayed at a time interval set by, for example, the game application or an operating system (OS).

Hereinafter, details of the operations of the display control unit 120 and the control unit 100 will be described.

### [Case Where Battery Information Indicates State (First State) in Which Remaining Battery Level or Remaining Operable Time is Equal to or Greater Than First Threshold]

In this case, the battery 250 has a sufficient amount of power. The display control unit 120 controls an image to be displayed on the display unit 230 using the spatial data. More specifically, the display control unit 120 generates an image to be displayed on the display unit 230 using the captured image (both the near view image and the distant view image) in the spatial data, and superimposes the object provided from the game application execution unit 270 on the generated image. The display control unit 120 sends the image data on which the object is superimposed to the display unit 230. The display unit 230 performs the image display on the basis of the image data from the control unit 100. The display control unit 120 may perform image processing such as smoothing processing (noise removal processing) noise removal, luminance correction, and contrast correction on the captured image of the camera 210. Alternatively, the image processing may be performed by the space recognition unit 110, and the captured image included in the spatial data may be an image after the image processing. The display control unit 120 may control an image to be displayed using the depth information in addition to the captured image. Therefore, higher quality display can be made by increasing contrast.

Furthermore, in a case where the battery information indicates the first state, the control unit 100 transmits an upload request of the distant view spatial data (for example, the distant view image, the depth information, the position information, and the orientation information) to the server. The server records the distant view image, the depth information, the position information, and the orientation information included in the distant view spatial data in the internal database. Here, the upload request includes the distant view image, the depth information, the position information, and the orientation information, but the upload request is only required to include the distant view image and at least one of the depth information, the position information, and the orientation information.

### [Case Where Battery Information Indicates State (Second State) in Which Remaining Battery Level or Remaining Operable Time is Less Than First Threshold]

The processing is changed depending on whether or not the remaining battery level or the remaining operable time is equal to or greater than a threshold (second threshold). The second threshold is a value smaller than the first threshold.

### <Case Where Remaining Battery Level or Remaining Operable Time is Less Than Second Threshold>

In this case, the amount of power stored in the battery 250 is small. The display control unit 120 controls an image (first partial display image) to be displayed in a part of the display region of the display unit 230 using the near view image included in the spatial data. An image to be displayed may be controlled using the depth information corresponding to the near view image in addition to the near view image. Therefore, higher quality display can be made by increasing contrast. The near view image and the depth information thereof may be referred to as a near view image with depth information. A region part where the near view image is displayed corresponds to a near view display region or a first region part of the display region. Naturally, in a case where the range of the near view image in the captured image changes, the range of the near view display region or the first region part also changes.

For the remaining part of the display region of the display unit 230 (a distant view display region or a second region part), the display of an image (a second partial display image) is controlled using the fixed image stored in the storage unit 280. The second region part or the distant view display region is originally a region part where the distant view image is displayed in the display region. Naturally, in a case where the range of the distant view image in the captured image changes, the range of the distant view display region or the second region part also changes. The load of the above-described image processing can be reduced by using a fixed image prepared in advance for the image display in the distant view display region. Furthermore, in a case where the position and orientation of the HMD 1000 do not change, the fixed image can be continuously displayed in the same region, so that the load of the display processing can also be reduced. The power consumption of the HMD 1000 can be reduced by reducing the load of the image processing and reducing the display processing. The fixed image is an example of an image (second image) different from the image captured by the camera 210.

### <Case Where Remaining Battery Level or Remaining Operable Time is Equal to or Greater Than Second Threshold and Less Than First Threshold>

For the near view display region of the display unit 230, the display control unit 120 controls an image to be displayed using the near view image and the like, similar to the above-described <Case where remaining battery level or remaining operable time is less than second threshold>.

For the distant view display region, the display control unit 120 downloads, from the server (the server 700 or the selection server), the distant view image with depth information according to the position and orientation of the HMD 1000 without using the distant view image included in the captured image of the camera. Specifically, the display control unit 120 transmits an acquisition request including at least one of the position information and the orientation information of the HMD 1000 to the server. The server acquires the distant view image according to at least one of the position information and the orientation information of the HMD 1000 and the depth information (the distant view image with depth information) corresponding to the distant view image, from the internal database. Here, a case is assumed in which the acquisition request includes both the position information and the orientation information, but the acquisition request may include only one of the position information and the orientation information. The server transmits an acquisition response including the acquired distant view image with depth information and the position information and orientation information corresponding to the distant view image, to the display control unit 120. The display control unit 120 controls an image (second partial display image) to be displayed in the distant view display region of the display unit 230 using the distant view image with depth information, the position information, and the orientation information included in the acquisition response. Here, the acquisition response includes the distant view image, the depth information, the position information, and the orientation information, but the acquisition response may include at least the distant view image, and may further include at least one of the depth information, the position information, and the orientation information. The acquired distant view image is an example of an image (second image) different from the image captured by the camera 210. In this case, the second image (distant view image) includes all or at least a part of the environment part in which the distant view image (second partial image) different from the near view image (first partial image) is captured in the captured image of the camera. However, the position and orientation at which the second image (distant view image) is captured may be either the same as or different from the position and orientation at which the distant view image (second partial image) is captured in the captured image of the camera.

In a case where the position information and orientation information that match the position information and orientation information included in the acquisition request are stored in the database, the server is only required to read the distant view image with depth information corresponding to the position information and orientation information from the database and provide the distant view image with depth information. In a case where the position information and orientation information that match the position information and orientation information included in the acquisition request are not stored in the database, the server acquires the corresponding distant view image, the depth information thereof, and the like from the database on the basis of the position information and orientation information included in the acquisition request and the angle of view (imaging range) of the camera 210. It is assumed that the server knows in advance the angle of view (imaging range) of the camera of each HMD and the angle of view (imaging range) of the depth sensor, or has acquired the angle of view from each HMD by communication. The server transmits an acquisition response including the acquired distant view image and depth information thereof and the position information and orientation information corresponding to the acquired distant view image, to the HMD 1000. A more detailed description will be given later.

The display control unit 120 deforms the acquired distant view image according to a difference between the position information and orientation information of the HMD 1000 and the position information and orientation information included in the acquisition response. For the deformation of the distant view image, for example, a principle based on triangulation such as epipolar constraint can be applied using the depth information included in the acquisition response. Therefore, the position of the object included in the distant view image viewed from the position and orientation different from those of the HMD 1000 can be reflected on the position of the object viewed from the position and orientation of the HMD 1000 with high accuracy. Note that, in a case where all of the distant view images required for the display by the HMD 1000 cannot be acquired from the server, a part that cannot be acquired may be generated by complementing the acquired distant view images. Alternatively, the part that cannot be acquired may be supplemented with the fixed image described above. Furthermore, the deformation of the image may be performed not by the display control unit 120 but by a server. In this case, the server transmits the deformed distant view image to the HMD 1000.

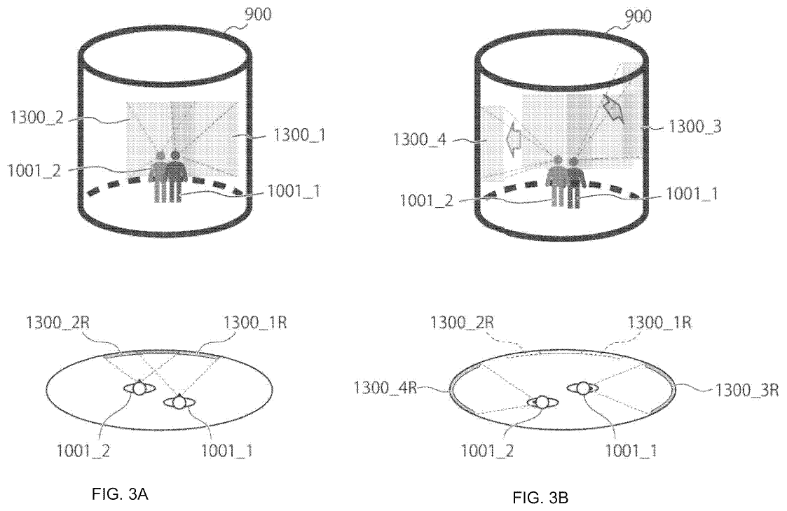

FIG. 3 illustrates an example in which a server acquires a distant view image and the like from a plurality of HMDs and stores the distant view image and the like in a database, and extracts and provides the corresponding distant view image and the like from the database in response to an acquisition request of the HMD. Note that the example of FIG. 3 is an example, and a distant view image and the like may be stored and provided using other methods.

FIG. 3(A) schematically illustrates an example in which a model (spatial model) 900M of a place or space 900 shared by a plurality of users is arranged in a coordinate system. A plan view of the spatial model 900M is illustrated on a lower side of FIG. 3(A). The shape of the spatial model 900M is an elliptical columnar shape, but the shape of the space may be another shape. Users 1001_1 and 1001_2 are schematically illustrated in the spatial model 900M. The server projects the distant view image acquired from the HMD on a boundary surface of the spatial model 900M in the position and the line-of-sight direction of the user (the position and orientation of the HMD), and manages a projection region where the distant view image has been projected, as a region where the distant view image has been acquired. The server stores the distant view image, the depth information, the position information, the orientation information, and the information on the projection region that are acquired from the HMD, in the database. In the figure, an image 1300 1 obtained by projecting a distant view image acquired from the HMD 1000_1 of the user 1001_1 onto the spatial model 900M, and an image 1300 2 obtained by projecting a distant view image acquired from the HMD 1000_2 worn by the user 1001_2 are illustrated. Note that the image 1300 1 and the image 1300 2 partially overlap each other. A region 1300_1R corresponding to the image 1300_1 and a region 1300_2R corresponding to the image 1300_2 are illustrated on the lower side of FIG. 3(A). That is, the projection region where the distant view image has been acquired in the boundary region of the spatial model 900M is illustrated on the lower side of FIG. 3(A).

In FIG. 3(B), the line-of-sight direction of each of the users 1001 1 and 1001 2 is changed, whereby the orientations of the HMDs 1000_1 and 1000_2 are changed. An image 1300_3 obtained by projecting a distant view image newly acquired from the HMD 1000_1 and an image 1300_4 obtained by projecting a distant view image newly acquired from the HMD 1000_2 are illustrated. A region 1300_3R corresponding to the image 1300_3 and a region 1300_4R corresponding to the image 1300_4 are illustrated on the lower side of FIG. 3(B). As described above, the distant view image is acquired every time the orientation of the HMD is changed, and the projection region where the distant view image has been acquired is increased in the boundary region of the spatial model 900M. Note that, in a case where the images obtained by projecting the two distant images partially overlap each other, both the distant images may be stored as they are, or the overlapping part may be deleted from one of the distant images. In a case where the overlapping part is deleted, the depth information part corresponding to the deleted image part is only required to be deleted.

In a case where the server receives the acquisition request from the HMD 1000, the server projects the distant image onto the boundary surface of the space 900 on the basis of the position information and orientation information included in the acquisition request. The server specifies a common part (overlapping part) between the projected region (target projection region) and the projection region corresponding to the accumulated distant image. The distant image corresponding to the specified common part, and the depth information, the position information, and the orientation information corresponding to the distant image are read from the database, and are transmitted to the HMD 1000 as the acquisition response. Note that, in a case where the target projection region overlaps with the plurality of projection regions, the distant image of the overlapping part and the depth information, the position information, and the orientation information corresponding to the distant image is only required to be transmitted as the acquisition response for each overlapping projection region.

As described above, the server with which the HMD communicates is not limited to the server 700 on the network 600, and may be an HMD (selection server) selected from among a plurality of HMDs. The selection server may function as a server that substitutes for the server 700 or a server that shares a part of the functions of the server 700. For example, the selection server may include a database storing a distant image and the like to function as a server, and the server 700 may be a server that manages battery information of each HMD. The server (the server 700 or the selection server) may have a function as a management server (for example, a server that performs account management, status management of a position and the like) of the game application.

In a case where a server is selected from among a plurality of HMDs, the control unit 100 of the HMD 1000 may compare the battery information of each HMD. In this case, the control unit 100 acquires the battery information of the other HMDs, compares the battery information of the HMD 1000 with the battery information of the other HMDs, and selects the HMD having the largest remaining battery level or remaining operable time as the server. The HMD 1000 may acquire the battery information of the other HMDs by communicating with the other HMDs or from the server 700.

Alternatively, the control unit 100 may select a server by applying an additional condition from among a plurality of HMDs in which the remaining battery level or the remaining operable time is equal to or greater than a certain value. The additional condition includes, for example, the lowest power consumption, the highest CPU performance, or the remaining memory capacity equal to or greater than a certain value. Other conditions may be applied to select a server from a plurality of HMDs.

The selection of the server may be performed at the start of the game. After the start of the game, the selection of the server may be repeated at regular time intervals. In a case where the selection of the server is repeatedly performed, there is a possibility that a distant image and the like are stored in a distributed manner in a plurality of HMDs, and thus, there is a possibility that a hit rate with respect to the acquisition request decreases. Therefore, in a case where the server is changed, the contents (the distant image and the like) of the database may be copied from the server (HMD) before the change to the server (HMD) after the change.

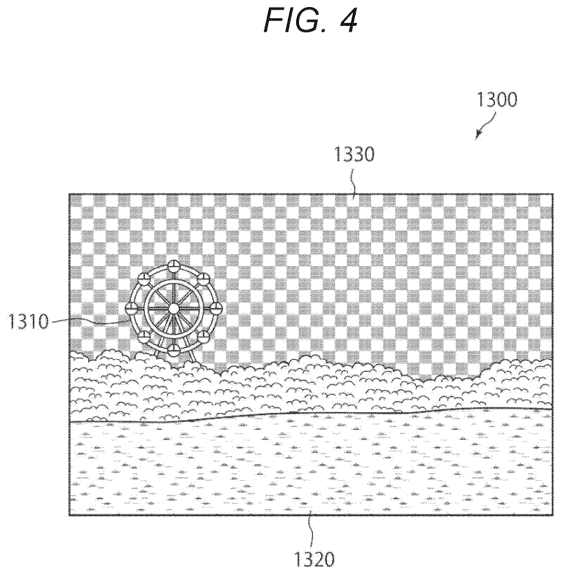

FIG. 4 illustrates an example of a display image 1300 displayed on the display unit 230 of the HMD 1000.

The image 1300 includes an image (near view image) 1320 in the near view display region, an image 1330 in the distant view display region, and an object 1310. The near view image 1320 corresponds to an example of the first partial display image displayed in the near view display region (first partial region of the display region). The image 1330 corresponds to an example of the second partial display image displayed in the distant view display region (second partial region of the display region). The object 1310 is a building object standing on a ground object. The image 1320 in the near view display region is on the basis of the near view image among the captured images captured by the camera 210, but the image 1330 in the distant view display region is a fixed image which is an image having predetermined contents.

An environment part corresponding to the near view image 1320 in the environment imaged by the camera 210 exists at a distance close to the user in the progress of the game, and the near view image 1320 is an image important to the user or the game. The near view image 1320 is an object (a ground object in this example) with which the object 1310 is directly in contact, and in a case where the near view image 1320 is replaced with another image (for example, a fixed image), the user may feel uncomfortable in the expression on the game. Therefore, it is difficult to replace the near view image 1320 with another image such as a fixed image in maintaining the quality of the game.

On the other hand, it can be said that an environment part corresponding to the distant view display region in the environment imaged by the camera 210 exists at a distance far from the user in the progress of the game, and is an image with low importance depending on the user or the game. In the example of FIG. 4, the image in the distant view display region is originally a background image (for example, an empty object). Therefore, even in a case where the distant view image in the captured image is replaced with another image (for example, a fixed image), there is no significant influence on the progress of the game. By replacing the distant image with the fixed image in this manner, the image processing amount or the display processing amount of the HMD can be reduced, and the power consumption can be suppressed.

As the image other than the fixed image, a distant image and the like downloaded from the server as described above can also be used. By using a distant image and the like downloaded from the server, it is possible to perform the image display closer to reality even in the distant view display region. However, in a case where the update frequency of the distant image in the server is slow, an image corresponding to the user's past environment may be displayed in the distant display region. Furthermore, as compared with the case of using the captured image of the camera, deterioration in accuracy or deterioration in image quality may occur. As described above, also in the case of using the distant image and the like downloaded from the server, similarly to the case of using the fixed image, the image processing amount or the display processing amount can be reduced, and the power consumption can be suppressed. For example, in a case where the downloaded distant image has been subjected to the image processing, it is not necessary to perform the image processing. Furthermore, in a case where the position and line-of-sight direction of the user are the same, it is also possible to continue to display the same downloaded distant image (it is not necessary to update the display every time the camera 210 captures an image).

As described above, the display unit 230 displays the image (near view image and the like) including at least a part of the image captured by the camera 210, so that the user can feel as if the user directly gazes at the real world via the display unit 230. Such a function is called video see-through. An object generated by the game application execution unit 270 or an object acquired from other HMDs is superimposed on the image (augmented reality: AR). Therefore, the user of the HMD 1000 can see the object and the like generated by the game application execution unit 270 as if the object exists in the real environment.

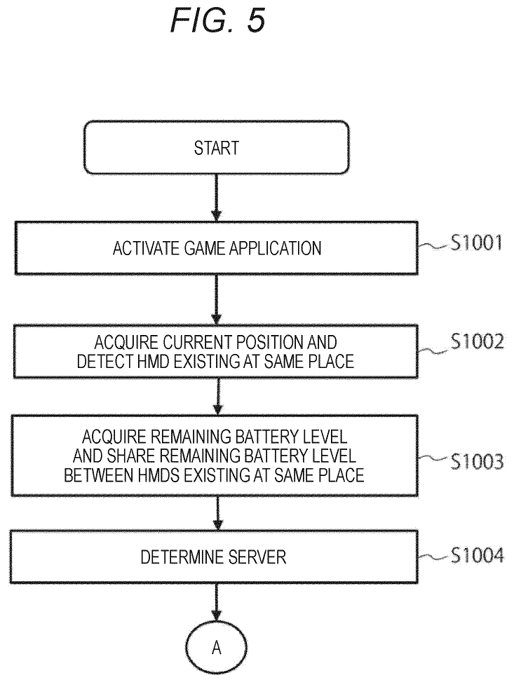

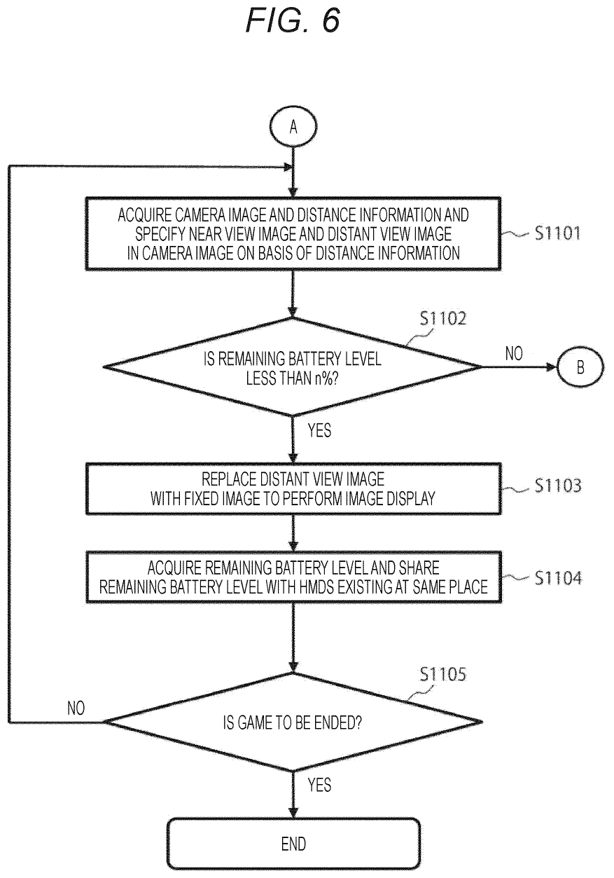

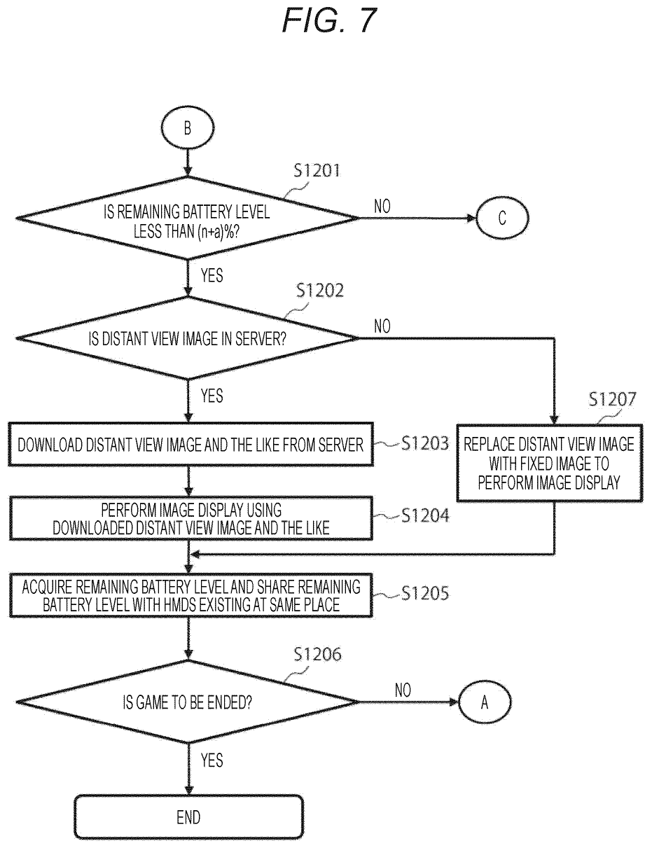

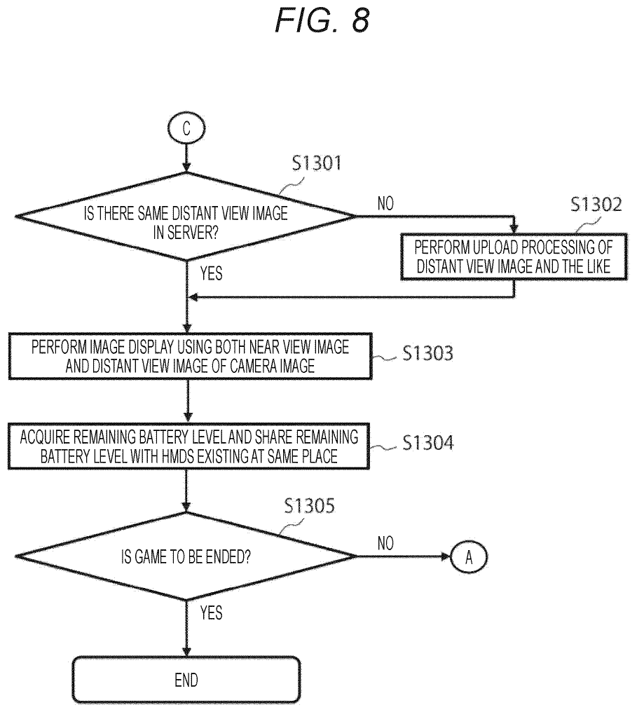

FIG. 5 illustrates a flowchart of an example of processing of the HMD 1000 according to the embodiment of the present disclosure. FIG. 6 illustrates a flowchart following FIG. 5. FIG. 7 illustrates a flowchart following FIG. 6. FIG. 8 illustrates a flowchart following FIG. 7. In the processing of FIGS. 5 to 8, an example is illustrated in which a server that manages a database of a distant view image and the like is selected from among a plurality of HMDs, and the server 700 is used as a server that manages the remaining battery level of each HMD. In a case where the server 700 is also used as a server that manages the database, the operation of sharing the remaining battery level of each HMD between the HMDs may be omitted. Furthermore, a server that manages the remaining battery level can be selected from among a plurality of HMDs.

The game application execution unit 270 of the HMD 1000 activates the game application (S1001).

The control unit 100 of the HMD 1000 acquires the current position of the HMD 1000, and detects other HMDs existing in the same place or the same space (S1002). That is, other HMDs that can execute a game while sharing the same place are detected. The user of the HMD 1000 starts a game with the users of other HMDs that are detected.

The control unit 100 of the HMD 1000 shares the remaining battery level with other HMDs (S1003). Specifically, the control unit 100 acquires the current remaining battery level from the remaining battery level management unit 140, and transmits (uploads) the acquired current remaining battery level to the server 700. Furthermore, the control unit 100 receives (downloads) the remaining battery level of other HMDs from the server 700. Therefore, the plurality of HMDs shares the remaining battery level.

The control unit 100 of the HMD 1000 selects the HMD having the highest remaining battery level as a server that manages the database (S1004). Other HMDs select a server in a similar manner. Since selection criteria of the server are the same between the HMDs, the same server is selected. Therefore, one same server is selected from among the plurality of HMDs. Processing of forming an agreement between the plurality of HMDs for the selected server may be performed. The server selected from among the plurality of HMDs is referred to as the selection server.

In FIG. 6, the control unit 100 of the HMD 1000 acquires the captured image and the depth information from the camera 210 and the depth sensor 220. Furthermore, the control unit 100 acquires the position information and the orientation information from the position/orientation acquisition unit 240. The control unit 100 specifies a near view image and a distant view image in the captured image on the basis of the depth information (S1101).

The control unit 100 of the HMD 1000 determines whether or not the remaining battery level of the HMD 1000 is less than a threshold (n %) on the basis of the battery information of the remaining battery level management unit 140 (S1102). The threshold (n %) corresponds to the second threshold as an example. A case where the battery is fully charged is 100%. In a case where the remaining battery level is less than n %, the control unit 100 replaces the distant view image in the captured image with a fixed image (S1103). The control unit 100 controls the image to be displayed on the display unit 230 on the basis of the near view image, the fixed image, and the object generated by the game application execution unit 270. The image processing such as noise removal and contrast correction described above may be performed on the near view image. The depth information of the near view image may be used to improve the display quality such as improvement of contrast in the image to be displayed. Furthermore, for the distant view display region, the fixed image is displayed, so that the image processing amount or the display processing amount can be reduced. Therefore, the power consumption of the HMD 1000 is reduced, and therefore, the remaining operable time of the HMD 1000 can be lengthened. In the progress of the game, a near view image that plays an important role such as contact with an object is not replaced with a fixed image, and an image of the camera 210 is used. Therefore, the quality of the game can be maintained.

The control unit 100 of the HMD 1000 acquires the current remaining battery level from the remaining battery level management unit 140 and shares the current remaining battery level with other HMDs (S1104). The remaining battery level is compared between the plurality of HMDs, and the server is reselected. The specific operation is similar to that in step S1003. Note that, in order to prevent the reselection of the server from being frequently performed, there may be various variations in the method of server selection, such as continuously selecting the same HMD as the server until the remaining battery level becomes less than a certain value.

The game application execution unit 270 of the HMD 1000 determines whether to end the game. For example, in a case where an end instruction is input from the user via an input unit, it is determined to end the game. In a case where the game is ended, the present processing is ended, and in a case where the game is not ended, the processing returns to step S1101.

When the remaining battery level is equal to or greater than the threshold no in step S1102 described above, the processing proceeds to step S1201 in FIG. 7. The control unit 100 of the HMD 1000 determines whether or not the remaining battery level of the HMD 1000 is less than a threshold (n+a) % (S1201). a is a positive real number, and n+a is a value greater than n. The threshold (n+a %) corresponds to the first threshold as an example.

In a case where the remaining battery level is less than the threshold (n+a) %, the control unit 100 transmits an acquisition request for the corresponding distant view image to the selection server on the basis of the position information and orientation information of the HMD 1000 (S1202). In a case where a response (acquisition response) indicating that the corresponding distant view image does not exist is received from the selection server, similarly to step S1103 described above, the distant view image in the captured image of the camera 210 is replaced with the fixed image, and the image display of the display unit 230 is controlled (S1207). After step S1207, the processing proceeds to step S1205.

In a case where the acquisition response including the distant view image and the like is received from the selection server, the control unit 100 of the HMD 1000 generates an image to be displayed on the basis of the distant view image and depth information thereof that are included in the acquisition response, for the distant view display region, and controls image display on the display unit 230 (S1203, S1204). Specifically, the distant view image is deformed on the basis of the depth information according to a difference between the position information and orientation information included in the acquisition request and the position information and orientation information of the HMD, and the image to be displayed on the display unit 230 is controlled on the basis of the deformed image. Therefore, it is possible to perform highly accurate display while using a distant view image acquired by another HHD at the position and orientation different from those of the HMD 1000. For the near view display region, similarly to step S1103, the image to be displayed on the display unit 230 is controlled on the basis of the near view image in the captured image of the camera 210 and the depth information thereof (S1204).

Steps S1205 and S1206 are the same as steps $1104 and S1105 in FIG. 6.

In a case where the remaining battery level is equal to or greater than the threshold (n+a) % in step S1201 described above, the processing proceeds to S1301 in FIG. 8. The control unit 100 of the HMD 1000 transmits an upload request for requesting uploading the distant view image and the depth information thereof, and the position information and orientation information of the HMD 1000, to the selection server. At this time, the control unit 100 transmits an inquiry to the selection server in advance to check whether an image corresponding to the distant view image already exists in the database of the selection server (S1301), and transmits an upload request in a case where an answer that the image does not exist yet (S1302). In order for the selection server to check whether an image corresponding to the distant view image already exists, the control unit 100 may transmit the position information and the orientation information. In a case where at least a part of the region projected on the spatial model on the basis of the position information and the orientation information is not yet recorded in the database as the projection region, the selection server may determine that an image corresponding to the distant view image does not yet exist. The image corresponding to the distant view image is one or a plurality of other distant view images including at least a part of the region obtained by projecting the distant view image onto the spatial model 900M as the projection region.

The control unit 100 controls the display to be displayed in the display region (the distant view display region and the near view display region) of the display unit 230 by using the captured image (the near view image and the distant view image) of the camera 210 and the depth information of the depth sensor 220 (S1303).

Steps S1304 and S1305 are the same as steps S1104 and S1105 in FIG. 6.

Furthermore, the effects of the present disclosure described in the present specification are merely an example, and other effects may be achieved.

Note that the present invention is not limited to the embodiments described above as it is, and can be embodied by modifying the components without departing from the gist thereof in the implementation stage. Furthermore, various inventions can be formed by appropriately combining the plurality of components disclosed in the embodiments described above. For example, some components may be deleted from all the components illustrated in the embodiments. Moreover, the components of different embodiments may be appropriately combined.

Note that the present disclosure can also have the following configurations.

### [Item 1]

An information processing device that performs processing based on a first image captured by a camera, the information processing device including:
a control unit that controls, in a case where state information indicating a state of the information processing device indicates a first state, a display image to be displayed in a display region on the basis of the first image, and
that controls, in a case where the state information indicates a second state, a first partial display image to be displayed in a first partial region of the display region on the basis of the first image, and controls a second partial display image to be displayed in a second partial region of the display region on the basis of a second image different from the first image.

### [Item 2]

The information processing device according to Item 1,
in which the state information is information based on a remaining level of battery that provides operating power of the information processing device.

### [Item 3]

The information processing device according to Item 2,
in which the first state indicates that the remaining level of the battery or a remaining operable time of the information processing device is equal to or greater than a first threshold, and
the second state indicates that the remaining level of the battery or the remaining operable time is less than the first threshold.

### [Item 4]

The information processing device according to Item 3,
in which in a case where the remaining level of the battery or the remaining operable time is less than the first threshold and equal to or greater than a second threshold, the control unit sets an image acquired from a server according to a position and an orientation of the information processing device as the second image, and
in a case where the remaining level of the battery or the remaining operable time is less than the second threshold, the control unit sets an image having predetermined contents as the second image.

### [Item 5]

The information processing device according to Item 4,
in which the control unit transmits an acquisition request of an image according to the position and the orientation of the information processing device to acquire the image, and
in a case where a response indicating that the image according to the position and the orientation of the information processing device does not exist in the server, the control unit sets the image having the predetermined contents as the second image.

### [Item 6]

The information processing device according to any one of Items 1 to 5, further including:
a depth acquisition unit that acquires depth information sensed by a depth sensor that measures a depth value,
in which in a case where the state information indicates the second state, the control unit specifies a first partial image satisfying a depth condition on the basis of the depth information, in the first image, and
the control unit controls the first partial display image to be displayed in the first partial region on the basis of the first partial image.

### [Item 7]

The information processing device according to Item 6,
in which the depth condition is that the depth value indicated by the depth information is less than a reference value.

### [Item 8]

The information processing device according to Item 6 or 7,
in which in a case where the state information indicates the second state, the control unit sets an image acquired from a server according to a position and an orientation of the information processing device as the second image, and
the second image includes at least a part of an environment part in which a second partial image different from the first partial image is captured in the first image in a surrounding environment of the information processing device captured by the camera.

### [Item 9]

The information processing device according to Item 8,
in which in a case where the state information indicates the second state, the control unit controls the second partial display image to be displayed in the second partial region on the basis of the depth information acquired from the server according to the position and the orientation of the information processing device.

### [Item 10]

The information processing device according to any one of Items 1 to 9, further including:
an application execution unit that executes an application that generates an object according to at least one of a position and an orientation of the information processing device,
in which the control unit controls display of the object by superimposing the object on the first image.

### [Item 11]

The information processing device according to Item 9 or 10,
in which in a case where the state information indicates the first state,
the control unit transmits an upload request to the server, the upload request including
at least the second partial image different from the first partial image in the first image, and
at least one of the depth information corresponding to the second partial image, the position information of the information processing device, and the orientation information of the information processing device.

### [Item 12]

The information processing device according to any one of Items 1 to 11,
in which the control unit acquires information based on a remaining level of a battery of one or more other information processing devices that are able to communicate with the information processing device, and selects a server from among the information processing device and the other information processing devices on the basis of the acquired information,
in a case where the state information indicates the first state, the control unit specifies a second partial image different from a first partial image satisfying a depth condition on the basis of depth information as the first image, and
the control unit transmits an upload request to the server, the upload request including
the second partial image, and
at least one of the depth information corresponding to the second partial image, position information of the information processing device, and orientation information of the information processing device.

### [Item 13]

The information processing device according to Item 12,
in which in a case where the information processing device is selected as the server, the control unit holds data including the image and at least one of the depth information, the position information, and the orientation information on the basis of the upload request from the other information processing devices, and
in a case where an acquisition request of the image including at least one of the position information and the orientation information is received from the other information processing devices, the control unit acquires at least the image among the image and the depth information according to at least one of the position information and the orientation information, from the held data, and outputs an acquisition response including at least the acquired image to the other information processing devices.

### [Item 14]

The information processing device according to Item 12 or 13, further including:
an application execution unit that executes an application that generates an object according to at least one of a position and an orientation of the information processing device,
in which the control unit controls display of the object by superimposing the object on at least a part of the first image, and
the control unit detects a device that exists in a same place or space as the information processing device and that executes a same application as the application, and sets the detected device as the other information processing device.

### [Item 15]

The information processing device according to any one of Items 6 to 9, further including:
an application execution unit that executes an application that generates an object according to at least one of a position and an orientation of the information processing device,
in which the control unit controls display of the object by superimposing the object on at least a part of the first image, and
the control unit acquires the depth condition from the application.

### [Item 16]

The information processing device according to Item 4 or 5,
in which the control unit acquires information based on a remaining level of a battery of one or more other information processing devices that are able to communicate with the information processing device, and selects the server from among the information processing device and the other information processing devices on the basis of the acquired information.

### [Item 17]

The information processing device according to Item 8 or 9,
in which the control unit acquires information based on a remaining level of a battery of one or more other information processing devices that are able to communicate with the information processing device, and selects the server from among the information processing device and the other information processing devices on the basis of the acquired information.

### [Item 18]

The information processing device according to any one of Items 6 to 9,
in which the information processing device is a head mounted display, and
the head mounted display further includes
the camera,
the depth sensor, and
a display unit including the display region.

### [Item 19]

An information processing method including:
controlling, in a case where state information indicating a state of an information processing device indicates a first state, a display image to be displayed in a display region on the basis of a first image captured by a camera; and
controlling, in a case where the state information indicates a second state, a first partial display image to be displayed in a first partial region of the display region on the basis of the first image, and controlling a second partial display image to be displayed in a second partial region of the display region on the basis of a second image different from the first image.

### [Item 20]

A recording medium that stores a computer program causing a computer to execute:
a step of controlling, in a case where state information indicating a state of an information processing device indicates a first state, a display image to be displayed in a display region on the basis of a first image captured by a camera; and
a step of controlling, in a case where the state information indicates a second state, a first partial display image to be displayed in a first partial region of the display region on the basis of the first image, and controlling a second partial display image to be displayed in a second partial region of the display region on the basis of a second image different from the first image.

### REFERENCE SIGNS LIST

1000 Head mounted display (HMD)

100 Control unit

110 Space recognition unit

111 Image acquisition unit

112 Depth acquisition unit

120 Display control unit

130 Sharing determination unit

140 Remaining battery level management unit (state acquisition unit)

210 Camera

220 Depth sensor

230 Display unit

240 Position/orientation acquisition unit

250 Battery

260 Communication unit

270 Game application execution unit

280 Storage unit

500 Base station (relay device)

600 Network

700 Server

900 Space

1001_1, 1001_2 User

1300 Image

1310 Object

1320 Near view image

1330 Fixed image

1. An information processing device that performs processing based on a first image captured by a camera, the information processing device comprising:
a control unit that controls, in a case where state information indicating a state of the information processing device indicates a first state, a display image to be displayed in a display region on a basis of the first image, and
that controls, in a case where the state information indicates a second state, a first partial display image to be displayed in a first partial region of the display region on a basis of the first image, and controls a second partial display image to be displayed in a second partial region of the display region on a basis of a second image different from the first image.

2. The information processing device according to claim 1,
wherein the state information is information based on a remaining level of a battery that provides operating power of the information processing device.

3. The information processing device according to claim 2,
wherein the first state indicates that the remaining level of the battery or a remaining operable time of the information processing device is equal to or greater than a first threshold, and
the second state indicates that the remaining level of the battery or the remaining operable time is less than the first threshold.

4. The information processing device according to claim 3,
wherein in a case where the remaining level of the battery or the remaining operable time is less than the first threshold and equal to or greater than a second threshold, the control unit sets an image acquired from a server according to a position and an orientation of the information processing device as the second image, and
in a case where the remaining level of the battery or the remaining operable time is less than the second threshold, the control unit sets an image having predetermined contents as the second image.

5. The information processing device according to claim 4,
wherein the control unit transmits an acquisition request of an image according to the position and the orientation of the information processing device to acquire the image, and
in a case where a response indicating that the image according to the position and the orientation of the information processing device does not exist in the server, the control unit sets the image having the predetermined contents as the second image.

6. The information processing device according to claim 1, further comprising:
a depth acquisition unit that acquires depth information sensed by a depth sensor that measures a depth value,
wherein in a case where the state information indicates the second state, the control unit specifies a first partial image satisfying a depth condition on a basis of the depth information, in the first image, and
the control unit controls the first partial display image to be displayed in the first partial region on a basis of the first partial image.

7. The information processing device according to claim 6,
wherein the depth condition is that the depth value indicated by the depth information is less than a reference value.

8. The information processing device according to claim 6,
wherein in a case where the state information indicates the second state, the control unit sets an image acquired from a server according to a position and an orientation of the information processing device as the second image, and
the second image includes at least a part of an environment part in which a second partial image different from the first partial image is captured in the first image in a surrounding environment of the information processing device captured by the camera.

9. The information processing device according to claim 8,
wherein in a case where the state information indicates the second state, the control unit controls the second partial display image to be displayed in the second partial region on a basis of the depth information acquired from the server according to the position and the orientation of the information processing device.

10. The information processing device according to claim 1, further comprising:
an application execution unit that executes an application that generates an object according to at least one of a position and an orientation of the information processing device,
wherein the control unit controls display of the object by superimposing the object on at least a part of the first image.

11. The information processing device according to claim 9,
wherein in a case where the state information indicates the first state,
the control unit transmits an upload request to the server, the upload request including
at least the second partial image different from the first partial image in the first image, and
at least one of the depth information corresponding to the second partial image, the position information of the information processing device, and the orientation information of the information processing device.

12. The information processing device according to claim 1,
wherein the control unit acquires information based on a remaining level of a battery of one or more other information processing devices that are able to communicate with the information processing device, and selects a server from among the information processing device and the other information processing devices on a basis of the acquired information,
in a case where the state information indicates the first state, the control unit specifies a second partial image different from a first partial image satisfying a depth condition on a basis of depth information as the first image, and
the control unit transmits an upload request to the server, the upload request including
the second partial image, and
at least one of the depth information corresponding to the second partial image, position information of the information processing device, and orientation information of the information processing device.

13. The information processing device according to claim 12,
wherein in a case where the information processing device is selected as the server, the control unit holds data including the image and at least one of the depth information, the position information, and the orientation information on a basis of the upload request from the other information processing devices, and
in a case where an acquisition request of the image including at least one of the position information and the orientation information is received from the other information processing devices, the control unit acquires at least the image among the image and the depth information according to at least one of the position information and the orientation information, from the held data, and outputs an acquisition response including at least the acquired image to the other information processing devices.

14. The information processing device according to claim 12, further comprising:
an application execution unit that executes an application that generates an object according to at least one of a position and an orientation of the information processing device,
wherein the control unit controls display of the object by superimposing the object on at least a part of the first image, and
the control unit detects a device that exists in a same place or space as the information processing device and that executes a same application as the application, and sets the detected device as the other information processing device.

15. The information processing device according to claim 6, further comprising:
an application execution unit that executes an application that generates an object according to at least one of a position and an orientation of the information processing device,
wherein the control unit controls display of the object by superimposing the object on at least a part of the first image, and
the control unit acquires the depth condition from the application.

16. The information processing device according to claim 4,
wherein the control unit acquires information based on a remaining level of a battery of one or more other information processing devices that are able to communicate with the information processing device, and selects the server from among the information processing device and the other information processing devices on a basis of the acquired information.

17. The information processing device according to claim 8,
wherein the control unit acquires information based on a remaining level of a battery of one or more other information processing devices that are able to communicate with the information processing device, and selects the server from among the information processing device and the other information processing devices on a basis of the acquired information.

18. The information processing device according to claim 6,
wherein the information processing device is a head mounted display, and
the head mounted display further includes
the camera,
the depth sensor, and
a display unit including the display region.

19. An information processing method comprising:
controlling, in a case where state information indicating a state of an information processing device indicates a first state, a display image to be displayed in a display region on a basis of a first image captured by a camera; and
controlling, in a case where the state information indicates a second state, a first partial display image to be displayed in a first partial region of the display region on a basis of the first image, and controlling a second partial display image to be displayed in a second partial region of the display region on a basis of a second image different from the first image.

20. A recording medium that stores a computer program causing a computer to execute:
a step of controlling, in a case where state information indicating a state of an information processing device indicates a first state, a display image to be displayed in a display region on a basis of a first image captured by a camera; and
a step of controlling, in a case where the state information indicates a second state, a first partial display image to be displayed in a first partial region of the display region on a basis of the first image, and controlling a second partial display image to be displayed in a second partial region of the display region on a basis of a second image different from the first image.
